(19) United States
(12) Patent Application Publication
(10) Pub. No.: US 2023/0074439 A1
(43) Pub. Date: Mar. 9, 2023

(54) Network Device, Terminal Device, and Methods Therein

(71) Applicant: Telefonaktiebolaget LM Ericsson (publ), Stockholm (SE)

(72) Inventors: Zhipeng Lin, Nanjing Jiangsu (CN); Jonas Sedin, Sollentuna (SE)

(21) Appl. No.: 17/793,095

(22) PCT Filed: Jan. 15, 2021
(86) PCT No.: PCT/CN2021/072062

§ 371 Date: Jul. 15, 2022

(30) Foreign Application Priority Data
Jan. 17, 2020 (CN) PCT/CN2020/072797

(51) Int. Cl. H04W 74/00; H04W 74/08

(52) U.S. Cl. CPC H04W 74/006; H04W 74/0833

(57) ABSTRACT

The present disclosure provides a method (400) in a network device. The method (400) includes: transmitting (410), to a terminal device, Downlink Control Information, DCI, addressed to a Random Access-Radio Network Temporary Identity, RA-RNTI, of the terminal device, the DCI containing an indication of a System Frame Number, SFN.

### TECHNICAL FIELD

The present disclosure relates to wireless communication, and more particularly, to a network device, a terminal device, and methods therein.

### BACKGROUND

Random access is performed by a terminal device, e.g., User Equipment (UE), in wireless networks, e.g., New Radio (NR) and Long Term Evolution (LTE) networks, for accessing to a new cell. Once a random access procedure is completed, a terminal device can be connected to a network device, e.g., evolved NodeB (eNB) or (next) generation NodeB (gNB), and communicate with the network device.

A four-step random access procedure has been defined for the NR. FIG. 1A shows a signaling sequence of a four-step random access procedure. As shown, at 101, a UE detects a Synchronization Signal (SS) from a gNB. At 102, the UE decodes Master Information Block (MIB) and System Information Block (SIB) (i.e., Remaining Minimum System Information (RMSI) and Other System Information (OSI), which may be distributed over multiple physical channels such as Physical Broadcast Channel (PBCH) and Physical Downlink Shared Channel (PDSCH), to acquire random access transmission parameters. At 111, the UE transmits a Physical Random Access Channel (PRACH) preamble, or Message 1 (Msg1), to the gNB. The gNB detects the Msg1 and responds with a Random Access Response (RAR), or Message 2 (Msg2), at 112. At 113, the UE transmits a Physical Uplink Shared Channel (PUSCH), or Message 3 (Msg3), to the gNB in accordance with configuration information for PUSCH transmission carried in the RAR. At 114, the gNB transmits a Contention Resolution Message (CRM), or Message 4 (Msg4), to the UE.

According to the 3^{rd} Generation Partnership Project (3GPP) Technical Specification (TS) 38.213, V15.7.0, which is incorporated herein by reference in its entirety, in the four-step random access procedure, the UE monitors the RAR in an RAR window, which starts at the first symbol of the earliest Control Resource Set (CORESET) the UE is configured to receive a Physical Downlink Control Channel (PDCCH) for a Type 1 PDCCH Common Search Space (CSS) set, that is, at least one symbol after the last symbol of the PRACH occasion (or referred to as Random Access Channel (RACH) occasion) corresponding to the PRACH transmission (the symbol duration corresponds to the Sub-Carrier Spacing (SCS) for Type 1 PDCCH CSS set). The length of the window, in numbers of slots (corresponding to the SCS for the Type 1 PDCCH CSS set), is provided by ra-Response Window defined as (referring to 3GPP TS 38.331, V15.7.0):
ra-Response Window: Msg2 (RAR) window length in number of slots. The network configures a value lower than or equal to 10 ms. UE ignores the field if included in SCellConfig.

In order to reduce the latency associated with random access, a two-step random access procedure has also been proposed for the NR. Instead of using the four steps 111˜114 as shown in FIG. 1A, the two-step random access procedure completes random access in only two steps with two messages, which may be referred to as Message A (MsgA) and Message B (MsgB), respectively. FIG. 1B shows a signaling sequence of a two-step random access procedure. As shown, the steps 101˜102 in FIG. 1B are the same as the steps 101˜102 in FIG. 1A. At 121, the UE transmits a PRACH preamble and a PUSCH in one message (i.e., MsgA) to the gNB. The PUSCH may include higher layer data such as Radio Resource Control (RRC) connection request, possibly with some small additional payload. At 122, the gNB transmits an RAR (referred to as MsgB in this case) to the UE, including UE identifier assignment, timing advance information and a CRM, etc.

According to 3GPP TS 38.213, V16.0.0, which is incorporated herein by reference in its entirety, in the two-step random access procedure, the UE monitors the RAR (MsgB) in an RAR window, which starts at the first symbol of the earliest CORESET the UE is configured to receive a PDCCH for a Type 1 PDCCH CSS set, that is, at least one symbol after the last symbol of the PUSCH occasion corresponding to the PUSCH transmission (the symbol duration corresponds to the SCS for the Type 1 PDCCH CSS set). The length of the RAR window, in numbers of slots (based on the SCS for the Type 1 PDCCH CSS set) can be extended to up to 40 ms, as agreed in the Radio Access Network 2 (RAN2) #108 meeting.

In addition, solutions for the NR to support Non-Terrestrial Networks (NTNs) have been studied in the 3GPP Release 16. An NTN refers to a network, or a segment thereof, using Radio Frequency (RF) resources on board a satellite or an Unmanned Aircraft System (UAS) platform. FIGS. 2A and 2B show typical scenarios where an NTN provides access to a UE. As shown, an NTN typically features the following elements:
one or more satellite gateways (sat-gateways) that connect the NTN to a public data network, including for example:
   a Geostationary Earth Orbit (GEO) satellite that is fed by one or more sat-gateways deployed across a satellite targeted coverage, e.g., regional or even continental coverage (assuming that UEs in a cell are served by only one sat-gateway), or
   a non-GEO satellite that is served successively by one or more sat-gateways at a time (the system ensures service and feeder link continuity between the successive serving sat-gateways with sufficient time duration to proceed with mobility anchoring and hand-over);
a feeder link or radio link between a sat-gateway and the satellite (or UAS platform);
a service link or radio link between a UE and the satellite (or UAS platform);
a satellite (or UAS platform) which may implement either a transparent or a regenerative (with on board processing) payload (the satellite (or UAS platform) generates beams over a given service area bounded by its field of view; the footprints of the beams are typically of elliptic shapes; the field of view of a satellite (or UAS platform) depends on its on-board antenna diagram and its minimum elevation angle), including for example:
   for a transparent payload (FIG. 2A): RF filtering, frequency conversion and amplification (the waveform signal repeated by the payload is un-changed);
   for a regenerative payload (FIG. 2B): RF filtering, frequency conversion and amplification as well as demodulation/decoding, switching and/or routing, and coding/modulation (this is effectively equivalent to having all or part of base station functions (e.g. gNB) on board the satellite (or UAS platform);
Inter-Satellite Links (ISLs) optionally in case of a constellation of satellites, which will require regenerative payloads on board the satellites (ISLs may operate in RF or optical bands); and
UEs that are served by the satellite (or UAS platform) within the targeted service area.

There are different types of satellites (or UAS platforms), as listed in Table 1 below.

TABLE 1
Types of NTN platforms

| | | | | Typical beam | |
|---|---|---|---|---|---|
| Platforms | Altitude range | | Orbit | footprint size | |
| Low-Earth Orbit | 300-1500 | km | Circular | 100-1000 | km |
| (LEO) satellite | | | around | | |
| Medium-Earth | 7000-25000 | km | the earth | 100-1000 | km |
| Orbit (MEO) | | | | | |
| satellite | | | | | |
| Geostationary | 35 786 | km | Notional | 200-3500 | km |
| Earth Orbit | | | station keeping | | |
| (GEO) satellite | | | position fixed | | |
| UAS platform | 8-50 | km | in terms of | 5-200 | km |
| (including | (20 | km | elevation/ | | |
| High Altitude | for HAPS) | | azimuth with | | |
| Platform Station | | | respect to a | | |
| (HAPS)) | | | given earth | | |
| | | | point | | |
| High Elliptical | 400-50000 | km | Elliptical | 200-3500 | km |
| Orbit (HEO) | | | around | | |
| satellite | | | the earth | | |

Typically, GEO satellites and UAS platforms are used to provide continental, regional or local services. A constellation of LEO and MEO satellites is used to provide services in both northern and southern hemispheres. In some cases, the constellation can even provide global coverage including polar regions, which will require appropriate orbit inclination, sufficient beams and ISLs.

The final agreed work item for NR NTN has been approved in the RAN #86 meeting. The work item aims to specify enhancements identified for NR NTN, especially LEO and GEO, with implicit compatibility to support HAPS and Air to Ground (ATG) scenarios according to the following principles:
Frequency Division Duplex (FDD) is assumed for the core specification work for NR NTN. (This does not imply that Time Division Duplex (TDD) cannot be used for relevant scenarios such as HAPS and ATG.)
Earth fixed tracking area is assumed with Earth fixed and moving cells.
UEs with Global Navigation Satellite System (GNSS) capabilities are assumed.

In the description of the work item, some detailed objectives associated with random access have been proposed, including for example:
Definition of an offset of a start of an RAR window (ra-ResponseWindow) for NTN;
Introduction of an offset of a start of ra-ContentionResolutionTimer to resolve random access contention;
Solutions for resolving preamble ambiguity and extension of RAR window;

and
Adaptation for Msg3 scheduling (only for the case with pre-compensation of timing and frequency offset at UE side).

### SUMMARY

As discussed above, after transmitting a PRACH preamble (in Msg1 or MsgA), a UE monitors a PDCCH for an RAR (Msg2 or MsgB). The RAR window (ra-Response Window) starts a predetermined time interval after transmission of the Msg1 or MsgA. If no valid RAR is received in the RAR window, a new preamble will be transmitted. If more than a certain number of preambles have been transmitted, a random access failure will be reported to an upper layer.

In terrestrial communications, the RAR is expected to be received by the UE within a few milliseconds after transmission of the corresponding preamble. However, in an NTN, the transmission delay will be much higher and therefore the RAR may not be received by the UE within a time period specified for terrestrial communications.

It is an object of the present disclosure to provide a network device, a terminal device, and methods therein, capable of allowing an RAR to be monitored properly based on an RAR window, even in networks having high propagation delays, such as NTNs.

According to a first aspect of the present disclosure, a method in a network device is provided. The method includes: transmitting, to a terminal device, Downlink Control Information (DCI) addressed to a Random Access—Radio Network Temporary Identity (RA-RNTI) of the terminal device. The DCI contains an indication of a System Frame Number (SFN).

In an embodiment, the indication may include a number of Least Significant Bits (LSBs) of the SFN.

In an embodiment, the DCI may have a DCI Format 1_0.

In an embodiment, the network device may operate in an NTN.

According to a second aspect of the present disclosure, a method in a network device is provided. The method includes: determining an offset of a start of an RAR window for a terminal device. A gap between an end of a PRACH occasion and a start of a first available CORESET after the PRACH occasion that carries DCI scheduling an RAR is derivable from the offset. The method further includes: transmitting the RAR to the terminal device based on the offset.

According to a third aspect of the present disclosure, a method in a network device is provided. The method includes: determining an offset of a start of an RAR window for a terminal device. A gap between an end of a PUSCH occasion for transmission of a MsgA PUSCH and a start of a first available CORESET after the PUSCH occasion that carries DCI scheduling a MsgB is derivable from the offset. The method further includes: transmitting the MsgB to the terminal device based on the offset.

In an embodiment, the offset may indicate a time length equal to the gap or the gap minus a duration of one Orthogonal Frequency Division Multiplexing (OFDM) symbol corresponding to an SCS for a Type 1 PDCCH CSS set.

In an embodiment, the network device may operate in an NTN.

In an embodiment, the offset may be determined based on a type of the NTN. The type may include at least a satellite or a UAS.

In an embodiment, the method may further include: signaling the offset to the terminal device.

According to a fourth aspect of the present disclosure, a network device is provided. The network device includes a transceiver, a processor and a memory. The memory contains instructions executable by the processor whereby the network device is operative to perform the method according to the first, second, or third aspect.

According to a fifth aspect of the present disclosure, a computer readable storage medium is provided. The computer readable storage medium has computer program instructions stored thereon. The computer program instructions, when executed by a processor in a network device, cause the network device to perform the method according to the first, second, or third aspect.

According to a sixth aspect of the present disclosure, a method in a terminal device is provided. The method includes: receiving, from a network device, DCI addressed to an RA-RNTI of the terminal device. The DCI contains an indication of an SFN.

In an embodiment, the indication may include a number of LSBs of the SFN.

In an embodiment, the DCI may have a DCI Format 1_0.

In an embodiment, the terminal device may operate in an NTN.

According to a seventh aspect of the present disclosure, a method in a terminal device is provided. The method includes: obtaining an offset of a start of an RAR window. A gap between an end of a PRACH occasion and a start of a first available CORESET after the PRACH occasion that carries DCI scheduling an RAR is derivable from the offset. The method further includes: monitoring the RAR in the RAR window determined based on the offset.

According to an eighth aspect of the present disclosure, a method in a terminal device is provided. The method includes: obtaining an offset of a start of an RAR window. A gap between an end of a PUSCH occasion for transmission of a MsgA PUSCH and a start of a first available CORESET after the PUSCH occasion that carries DCI scheduling a MsgB is derivable from the offset. The method further includes: monitoring the MsgB in the RAR window determined based on the offset.

In an embodiment, the offset may indicate a time length equal to the gap or the gap minus a duration of one OFDM symbol corresponding to an SCS for a Type 1 PDCCH CSS set.

In an embodiment, the terminal device may operate in an NTN.

In an embodiment, the operation of obtaining may include: determining the offset based on a type of the NTN. The type may include at least a satellite or an UAS.

In an embodiment, the operation of obtaining may include: receiving the offset from a network device.

According to a ninth aspect of the present disclosure, a method in a terminal device is provided. The method includes: determining, in an RAR window, a time period during which the terminal device is not to monitor an RAR from a network device; and monitoring, in the RAR window, the RAR after the time period has lapsed.

In an embodiment, the time period may be determined based on one or more of: a distance between the terminal device and the network device, a location of the terminal device, or a previously determined time period during which the terminal device refrained from monitoring an RAR in an RAR window.

In an embodiment, the terminal device may operate in an NTN.

According to a tenth aspect of the present disclosure, a terminal device is provided. The terminal device includes a transceiver, a processor and a memory. The memory contains instructions executable by the processor whereby the terminal device is operative to perform the method according to the sixth, seventh, eighth, or ninth aspect.

According to an eleventh aspect of the present disclosure, a computer readable storage medium is provided. The computer readable storage medium has computer program instructions stored thereon. The computer program instructions, when executed by a processor in a terminal device, cause the terminal device to perform the method according to the sixth, seventh, eighth, or ninth aspect.

With the embodiments of the present disclosure, an indication of an SFN can be included in DCI addressed to an RA-RNTI, thereby allowing an RAR window to be extended e.g., to a multiple of 10 ms. Alternatively, an offset of a start of an RAR window can be introduced, thereby allowing a terminal device to monitor an RAR properly in case of a high transmission delay. In this way, an RAR can be monitored properly based on an RAR window, even in a network having a high propagation delay, such as an NTN.

### BRIEF DESCRIPTION OF THE DRAWINGS

The above and other objects, features and advantages will be more apparent from the following description of embodiments with reference to the figures, in which:

FIG. 1A is a sequence diagram showing a four-step random access procedure;

FIG. 1B is a sequence diagram showing a two-step random access procedure;

FIG. 2A is a schematic diagram showing a typical scenario of an NTN having a transparent payload;

FIG. 2B is a schematic diagram showing a typical scenario of an NTN having a regenerative payload;

FIG. 3 is a schematic diagram showing an example of an RAR window;

FIG. 4 is a flowchart illustrating a method in a network device according to an embodiment of the present disclosure;

FIG. 5 is a flowchart illustrating a method in a network device according to another embodiment of the present disclosure;

FIG. 6 is a flowchart illustrating a method in a network device according to yet another embodiment of the present disclosure;

FIG. 7 is a flowchart illustrating a method in a terminal device according to an embodiment of the present disclosure;

FIG. 8 is a flowchart illustrating a method in a terminal device according to another embodiment of the present disclosure;

FIG. 9 is a flowchart illustrating a method in a terminal device according to yet another embodiment of the present disclosure;

FIG. 10 is a flowchart illustrating a method in a terminal device according to still another embodiment of the present disclosure;

FIG. 11 is a block diagram of a network device according to an embodiment of the present disclosure;

FIG. 12 is a block diagram of a network device according to another embodiment of the present disclosure;

FIG. 13 is a block diagram of a terminal device according to another embodiment of the present disclosure;

FIG. 14 is a block diagram of a terminal device according to another embodiment of the present disclosure;

FIG. 15 schematically illustrates a telecommunication network connected via an intermediate network to a host computer;

FIG. 16 is a generalized block diagram of a host computer communicating via a base station with a user equipment over a partially wireless connection; and

FIGS. 17 to 20 are flowcharts illustrating methods implemented in a communication system including a host computer, a base station and a user equipment.

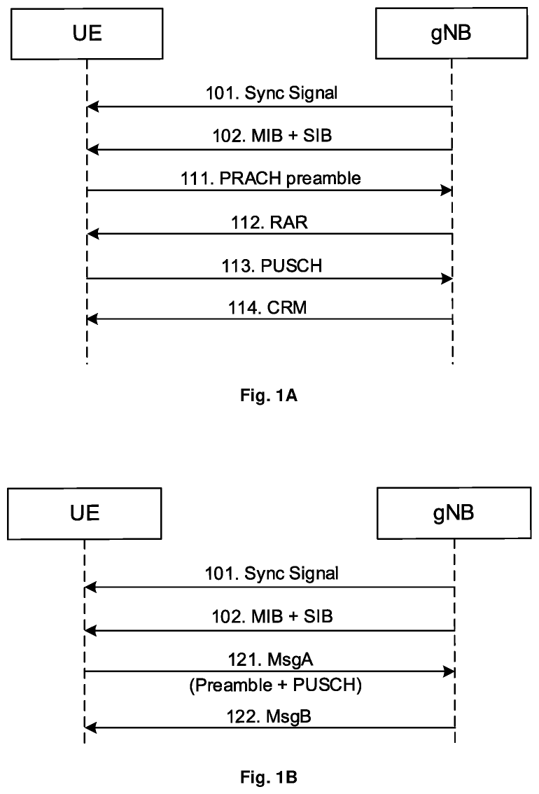

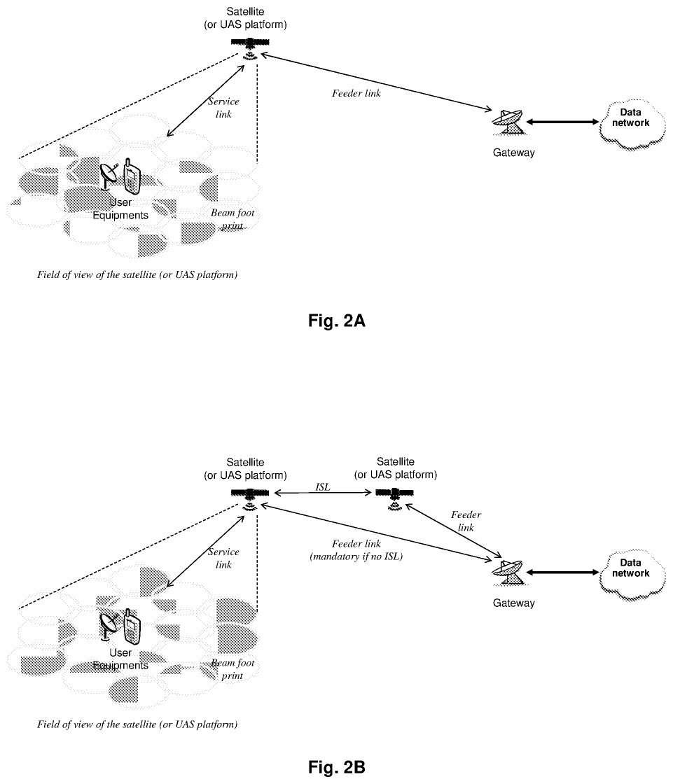

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or gNB, a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network device may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from a network device to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

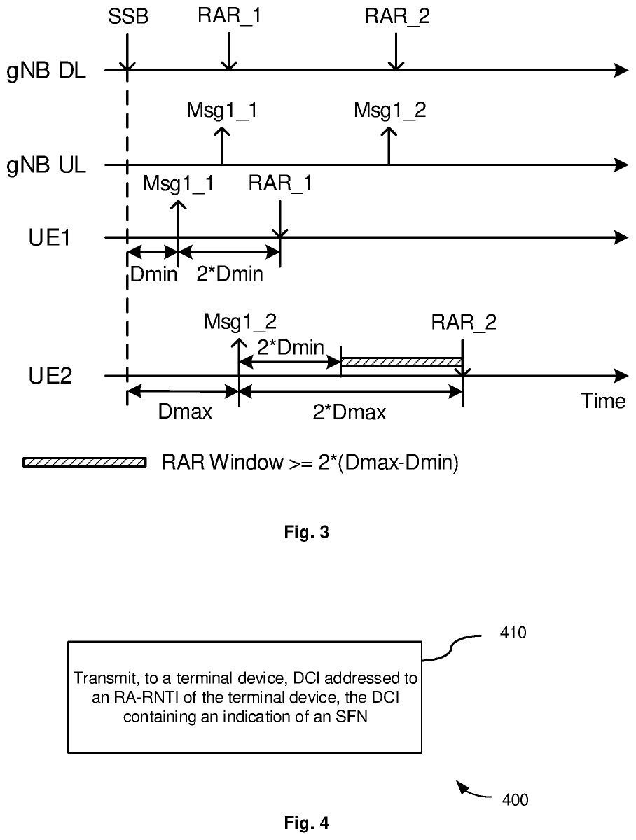

FIG. 3 shows a worst case in which a UE (denoted as UE1) with a minimum one-way transmission delay (denoted as Dmin) and a UE (denoted as UE2) with a maximum one-way transmission delay (denoted as Dmax) initiate random access using the same time-frequency resource. It is assumed here that a configured offset to delay a start of an RAR window equals to 2*Dmin and a processing delay between reception of a preamble (e.g., Msg1 in this case) and transmission of an RAR at a gNB is negligible. In FIG. 3, from top to bottom, the first line shows the downlink (DL) TX (transmission) timing at the gNB for transmitting an RAR (RAR_1) to UE1 and an RAR (RAR_2) to UE2, the second line shows the uplink (UL) RX (reception) timing at the gNB for receiving a Msg1 (Msg1_1) from UE1 and a Msg1 (Msg1_2) from UE2, the third line shows TX/RX timing at UE1 for transmitting Msg1_1 and receiving RAR_1, and the fourth line shows TX/RX timing at UE2 for transmitting Msg1_2 and receiving RAR_2. It can be seen from the fourth line in FIG. 3 that the RAR window for UE2 needs to cover at least 2*(Dmax−Dmin), otherwise RAR_2 will fall out of the RAR window and UE2 will not be able to monitor it. Here, the value of Dmax−Dmin within one cell is 10.3 ms for the GEO satellite and 3.18 ms for the LEO satellite. Accordingly, for the GEO case, 2*(Dmax−Dmin)=20.6 ms>10 ms, and for the LEO case, 2*(Dmax−Dmin)=6.36 ms<10 ms. Furthermore, time flexibility may be required for the gNB to schedule the RARs, which means several milliseconds should be added on top of 2*(Dmax−Dmin). Thus, extension of the RAR window may be required in both the GEO and LEO cases. When the RAR window, i.e., ra-Response Window, is extended, a number of LSBs of an SFN can be included in the RAR.

FIG. 4 is a flowchart illustrating a method 400 according to an embodiment of the present disclosure. The method 400 can be performed at a network device, e.g., a gNB, operating in an NTN.

At block 410, DCI addressed to an RA-RNTI of a terminal device is transmitted to the terminal device. The DCI contains an indication of an SFN.

For example, the indication may include a number of LSBs of the SFN. The number may be dependent on a length of an RAR window. For example, two LSBs of the SFN can be included for uniquely identifying each of four 10 ms periods within a 40 ms RAR window.

As an example, the following information can be included in DCI Format 1_0 with Cyclic Redundancy Check (CRC) scrambled by RA-RNTI or msgB-RNTI:
Frequency domain resource assignment—┌log₂(N_{RB}^{DL,BWP}(N_{RB}^{DL,BWP}+1)/2)┐ bits,
   where N_{RB}^{DL,BWP} is the size of CORESET 0 if CORESET 0 is configured for the cell, and N_{RB}^{DL,BWP} is the size of initial DL bandwidth part if CORESET 0 is not configured for the cell,
Time domain resource assignment—4 bits as defined in Subclause 5.1.2.1 of 3GPP TS 38.214, V16.0.0, which is incorporated herein by reference in its entirety,
Virtual Resource Block (VRB) to Physical Resource Block (PRB) mapping—1 bit according to Table 7.3.1.2.2-5 of 3GPP TS 38.212, V16.0.0, which is incorporated herein by reference in its entirety,
Modulation and coding scheme—5 bits as defined in Subclause 5.1.3 of TS 38.214, using Table 5.1.3.1-1,
Transport Block (TB) scaling—2 bits as defined in Subclause 5.1.3.2 of TS 38.214,
LSBs of SFN—2 bits for DCI Format 1_0 with CRC scrambled by msgB-RNTI or RA-RNTI for NTN operation; or 0 bit otherwise, and
Reserved bits—16 bits for DCI Format 1_0 with CRC scrambled by RA-RNTI not for the NTN operation; or 14 bits otherwise.

Here, as discussed above, the number of bits (LSBs) of SFN in DCI Format 1_0, addressed to msgB-RNTI or RA-RNTI (or any other appropriate RNTI), can be larger than 2, depending on the length of the RAR window. For further details of the other information included in DCI Format 1_0, reference can be made to TS 38.212, V16.0.0.

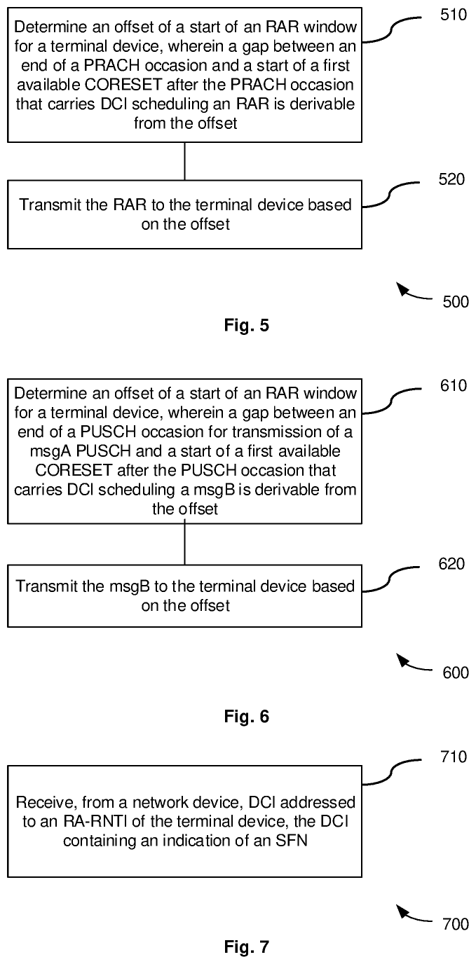

FIG. 5 is a flowchart illustrating a method 500 according to another embodiment of the present disclosure. The method 500 can be performed at a network device, e.g., a gNB, operating in an NTN, and can be applied in a four-step random access procedure.

At block 510, an offset of a start of an RAR window is determined for a terminal device. A gap between an end of a PRACH occasion and a start of the first (i.e., the earliest) available CORESET after the PRACH occasion that carries DCI scheduling an RAR is derivable from the offset. It is to be noted that, in the context of the present disclosure, a “PRACH occasion” may also be referred to as an “RACH occasion”, and they are equivalent to each other and can be used interchangeably.

At block 520, the RAR is transmitted to the terminal device based on the offset. For example, the DCI scheduling the RAR, and accordingly the RAR, will not be transmitted within the gap.

In an example, the offset may indicate a time length equal to the gap, or to the gap minus a duration of one OFDM symbol corresponding to an SCS for a Type 1 PDCCH CSS set. The benefit of the latter alternative is to maintain the requirement for terrestrial networks in the NR Release 15 and Release 16 that the gap should be at least one symbol, independently from the offset configured for e.g., an NTN. It can also reduce the signaling overhead of the offset especially when the timing unit of one symbol is used for signaling of the offset.

In an example, in the block 510, the offset can be determined based on a type of the NTN. The type may include at least a satellite (e.g., GEO or LEO) or an UAS. For example, different types of satellite or UAS platforms may have their respective predetermined values of offsets.

In an example, the offset can be signaled to the terminal device.

FIG. 6 is a flowchart illustrating a method 600 according to still another embodiment of the present disclosure. The method 600 can be performed at a network device, e.g., a gNB, operating in an NTN, and can be applied in a two-step random access procedure.

At block 610, an offset of a start of an RAR window is determined for a terminal device. A gap between an end of a PUSCH occasion for transmission of a MsgA PUSCH and a start of the first (i.e., the earliest) available CORESET after the PUSCH occasion that carries DCI scheduling a MsgB is derivable from the offset.

At block 620, the MsgB is transmitted to the terminal device based on the offset. For example, the DCI scheduling the MsgB, and accordingly the MsgB, will not be transmitted within the gap.

In an example, the offset may indicate a time length equal to the gap, or to the gap minus a duration of one OFDM symbol corresponding to an SCS for a Type 1 PDCCH CSS set. The benefit of the latter alternative is to maintain the requirement for terrestrial networks in the NR Release 15 and Release 16 that the gap should be at least one symbol, independently from the offset configured for e.g., an NTN. It can also reduce the signaling overhead of the offset especially when the timing unit of one symbol is used for signaling of the offset.

In an example, in the block 610, the offset can be determined based on a type of the NTN. The type may include at least a satellite (e.g., GEO or LEO) or an UAS. For example, different types of satellite or UAS platforms may have their respective predetermined values of offsets.

In an example, the offset can be signaled to the terminal device.

FIG. 7 is a flowchart illustrating a method 700 according to an embodiment of the present disclosure. The method 700 can be performed at a terminal device, e.g., a UE, operating in an NTN.

At block 710, DCI addressed to an RA-RNTI of the terminal device is received from a network device. The DCI contains an indication of an SFN. For example, the DCI may have a DCI Format 1_0, and the indication may include a number of LSBs of the SFN.

The DCI may correspond to the DCI transmitted in the block 410 of the method 400. For further details of the DCI and the indication, reference can be made to the method 400 as described above in connection with FIG. 4.

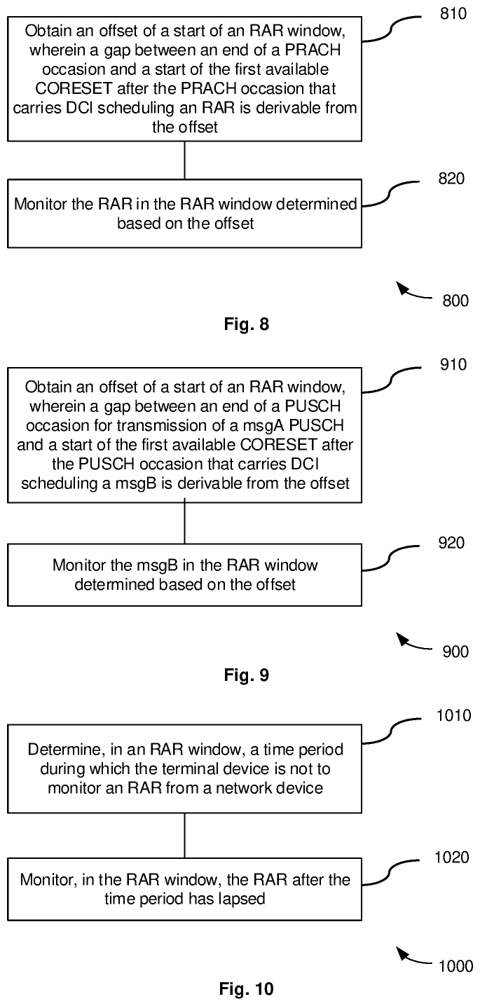

FIG. 8 is a flowchart illustrating a method 800 according to another embodiment of the present disclosure. The method 800 can be performed at a terminal device, e.g., a UE, operating in an NTN, and can be applied in a four-step random access procedure.

At block 810, an offset of a start of an RAR window is obtained. A gap between an end of a PRACH occasion and a start of the first (i.e., the earliest) available CORESET after the PRACH occasion that carries DCI scheduling an RAR is derivable from the offset.

At block 820, the RAR is monitored in the RAR window determined based on the offset. In particular, the terminal device can derive the gap from the offset, determine the start of the RAR window based on the PRACH occasion and the gap, and monitor the RAR in the RAR window.

In an example, the offset may indicate a time length equal to the gap, or to the gap minus a duration of one OFDM symbol corresponding to an SCS for a Type 1 PDCCH CSS set.

In an example, in the block 810, the offset can be determined at the terminal device based on a type of the NTN. The type may include at least a satellite (e.g., GEO or LEO) or an UAS. For example, different types of satellite or UAS platforms may have their respective predetermined values of offsets.

Alternatively, the offset can be received from a network device.

FIG. 9 is a flowchart illustrating a method 900 according to yet another embodiment of the present disclosure. The method 900 can be performed at a terminal device, e.g., a UE, operating in an NTN, and can be applied in a two-step random access procedure.

At block 910, an offset of a start of an RAR window is obtained. A gap between an end of a PUSCH occasion for transmission of a MsgA PUSCH and a start of the first (i.e., the earliest) available CORESET after the PUSCH occasion that carries DCI scheduling a MsgB is derivable from the offset.

At block 920, the MsgB is monitored in the RAR window determined based on the offset. In particular, the terminal device can derive the gap from the offset, determine the start of the RAR window based on the PUSCH occasion and the gap, and monitor the MsgB in the RAR window.

In an example, the offset may indicate a time length equal to the gap, or to the gap minus a duration of one OFDM symbol corresponding to an SCS for a Type 1 PDCCH CSS set.

In an example, in the block 910, the offset can be determined at the terminal device based on a type of the NTN. The type may include at least a satellite (e.g., GEO or LEO) or an UAS. For example, different types of satellite or UAS platforms may have their respective predetermined values of offsets.

Alternatively, the offset can be received from a network device.

FIG. 10 is a flowchart illustrating a method 1000 according to still another embodiment of the present disclosure. The method 1000 can be performed at a terminal device, e.g., a UE, operating in an NTN. The method 1000 can be applied in terminal device independently from, or in combination with, any of the above methods 400-900.

At block 1010, a time period during which the terminal device is not to monitor an RAR (e.g., Msg2 or MsgB) from a network device is determined in an RAR window. Accordingly, the terminal device can refrain from monitoring the RAR in the RAR window until the time period has lapsed.

The time period can be a part of the RAR window during which no RAR is expected to be received. For example, the time period can be determined based on a distance between the terminal device and the network device, or a one-way or round-trip propagation delay between the terminal device and the network device (which can be derived from the distance). Alternatively or additionally, the time period can be determined based on a location of the terminal device (which can be obtained from GNSS measurement associated with the terminal device).

Alternatively or additionally, the time period can be determined based on a previously determined time period during which the terminal device refrained from monitoring an RAR in an RAR window (this can be advantageous when the terminal device is relatively static).

At block 1020, in the RAR window, the RAR (e.g., Msg2 or MsgB) is monitored after the time period has lapsed.

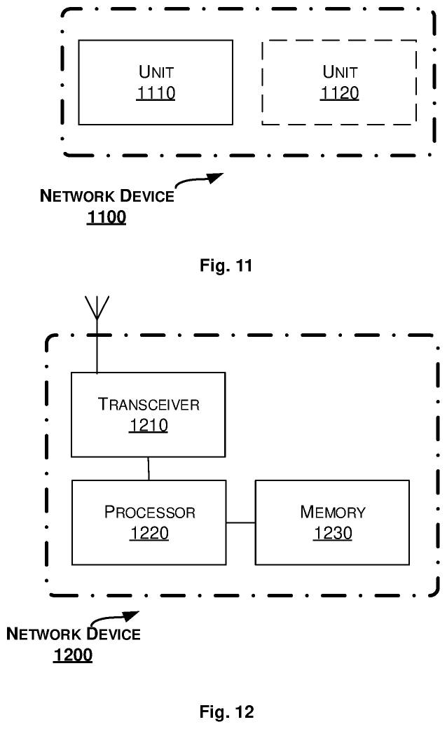

Correspondingly to the method 400, 500, or 600 as described above, a network device is provided. FIG. 11 is a block diagram of a network device 1100 according to an embodiment of the present disclosure. The network device 1100 can be e.g., a gNB, operating in an NTN.

The network device 1100 can be operative to perform the method 400 as shown in FIG. 4. As shown in FIG. 11, the network device 1100 includes a unit (transmitting unit) 1110 configured to transmit, to a terminal device, DCI addressed to an RA-RNTI of the terminal device. The DCI contains an indication of an SFN.

In an embodiment, the indication may include a number of LSBs of the SFN.

In an embodiment, the DCI may have a DCI Format 1_0.

Alternatively, the network device 1100 can be operative to perform the method 500 as shown in FIG. 5. As shown in FIG. 11, the network device 1100 includes a unit (determining unit) 1110 configured to determine an offset of a start of an RAR window for a terminal device. A gap between an end of a PRACH occasion and a start of a first available CORESET after the PRACH occasion that carries DCI scheduling an RAR is derivable from the offset. The network device 1100 further includes a unit (transmitting unit) 1120 configured to transmit the RAR to the terminal device based on the offset.

In an embodiment, the offset may indicate a time length equal to the gap or the gap minus a duration of one OFDM symbol corresponding to an SCS for a Type 1 PDCCH CSS set.

In an embodiment, the offset may be determined based on a type of the NTN. The type may include at least a satellite or a UAS.

In an embodiment, the unit 1120 may be further configured to signal the offset to the terminal device.

Alternatively, the network device 1100 can be operative to perform the method 600 as shown in FIG. 6. As shown in FIG. 11, the network device 1100 includes a unit (determining unit) 1110 configured to determine an offset of a start of an RAR window for a terminal device. A gap between an end of a PUSCH occasion for transmission of a MsgA PUSCH and a start of a first available CORESET after the PUSCH occasion that carries DCI scheduling a MsgB is derivable from the offset. The network device 1100 further includes a unit (transmitting unit) 1120 configured to transmit the MsgB to the terminal device based on the offset.

In an embodiment, the offset may indicate a time length equal to the gap or the gap minus a duration of one OFDM symbol corresponding to an SCS for a Type 1 PDCCH CSS set.

In an embodiment, the offset may be determined based on a type of the NTN. The type may include at least a satellite or a UAS.

In an embodiment, the unit 1120 may be further configured to signal the offset to the terminal device.

The units 1110 and 1120 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4, 5, or 6.

FIG. 12 is a block diagram of a network device 1200 according to another embodiment of the present disclosure. The network device 1200 can be e.g., a gNB, operating in an NTN.

The network device 1200 includes a transceiver 1210, a processor 1220 and a memory 1230. The memory 1230 may contain instructions executable by the processor 1220 whereby the network device 1200 is operative to perform the actions, e.g., of the procedure described earlier in conjunction with FIG. 4. Particularly, the memory 1230 contains instructions executable by the processor 1220 whereby the network device 1200 is operative to transmit, to a terminal device, DCI addressed to an RA-RNTI of the terminal device. The DCI contains an indication of an SFN.

In an embodiment, the indication may include a number of LSBs of the SFN.

In an embodiment, the DCI may have a DCI Format 1_0.

Alternatively, the memory 1230 may contain instructions executable by the processor 1220 whereby the network device 1200 is operative to perform the actions, e.g., of the procedure described earlier in conjunction with FIG. 5. Particularly, the memory 1230 contains instructions executable by the processor 1220 whereby the network device 1200 is operative to determine an offset of a start of an RAR window for a terminal device. A gap between an end of a PRACH occasion and a start of a first available CORESET after the PRACH occasion that carries DCI scheduling an RAR is derivable from the offset. The memory 1230 further contains instructions executable by the processor 1220 whereby the network device 1200 is operative to transmit the RAR to the terminal device based on the offset.

In an embodiment, the offset may indicate a time length equal to the gap or the gap minus a duration of one OFDM symbol corresponding to an SCS for a Type 1 PDCCH CSS set.

In an embodiment, the offset may be determined based on a type of the NTN. The type may include at least a satellite or a UAS.

In an embodiment, the memory 1230 may further contain instructions executable by the processor 1220 whereby the network device 1200 is operative to signal the offset to the terminal device.

Alternatively, the memory 1230 may contain instructions executable by the processor 1220 whereby the network device 1200 is operative to perform the actions, e.g., of the procedure described earlier in conjunction with FIG. 6. Particularly, the memory 1230 contains instructions executable by the processor 1220 whereby the network device 1200 is operative to determine an offset of a start of an RAR window for a terminal device. A gap between an end of a PUSCH occasion for transmission of a MsgA PUSCH and a start of a first available CORESET after the PUSCH occasion that carries DCI scheduling a MsgB is derivable from the offset. The memory 1230 further contains instructions executable by the processor 1220 whereby the network device 1200 is operative to transmit the MsgB to the terminal device based on the offset.

In an embodiment, the offset may indicate a time length equal to the gap or the gap minus a duration of one OFDM symbol corresponding to an SCS for a Type 1 PDCCH CSS set.

In an embodiment, the offset may be determined based on a type of the NTN. The type may include at least a satellite or a UAS.

In an embodiment, the memory 1230 may further contain instructions executable by the processor 1220 whereby the network device 1200 is operative to signal the offset to the terminal device.

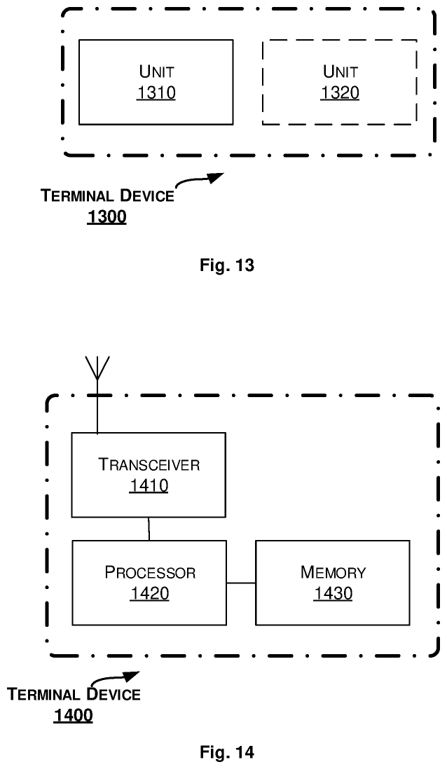

Correspondingly to the method 700, 800, 900, or 1000 as described above, a terminal device is provided. FIG. 13 is a block diagram of a terminal device 1300 according to an embodiment of the present disclosure. The terminal device 1300 can be e.g., a UE, operating in an NTN.

The terminal device 1300 can be operative to perform the method 700 as shown in FIG. 7. As shown in FIG. 13, the terminal device 1300 includes a unit (receiving unit) 1310 configured to receive, from a network device, DCI addressed to an RA-RNTI of the terminal device. The DCI contains an indication of an SFN.

In an embodiment, the indication may include a number of LSBs of the SFN.

In an embodiment, the DCI may have a DCI Format 1_0.

Alternatively, the terminal device 1300 can be operative to perform the method 800 as shown in FIG. 8. As shown in FIG. 13, the terminal device 1300 includes a unit (obtaining unit) 1310 configured to obtain an offset of a start of an RAR window. A gap between an end of a PRACH occasion and a start of a first available CORESET after the PRACH occasion that carries DCI scheduling an RAR is derivable from the offset. The terminal device 1300 further includes a unit (monitoring unit) 1320 configured to monitor the RAR in the RAR window determined based on the offset.

In an embodiment, the offset may indicate a time length equal to the gap or the gap minus a duration of one OFDM symbol corresponding to an SCS for a Type 1 PDCCH CSS set.

In an embodiment, the unit 1310 may be configured to determine the offset based on a type of the NTN. The type may include at least a satellite or an UAS.

In an embodiment, the unit 1310 may be configured to receive the offset from a network device.

Alternatively, the terminal device 1300 can be operative to perform the method 900 as shown in FIG. 9. As shown in FIG. 13, the terminal device 1300 includes a unit (obtaining unit) 1310 configured to obtain an offset of a start of an RAR window. A gap between an end of a PUSCH occasion for transmission of a MsgA PUSCH and a start of a first available CORESET after the PUSCH occasion that carries DCI scheduling a MsgB is derivable from the offset. The terminal device 1300 further includes a unit (monitoring unit) 1320 configured to monitor the MsgB in the RAR window determined based on the offset.

In an embodiment, the offset may indicate a time length equal to the gap or the gap minus a duration of one OFDM symbol corresponding to an SCS for a Type 1 PDCCH CSS set.

In an embodiment, the unit 1310 may be configured to determine the offset based on a type of the NTN. The type may include at least a satellite or an UAS.

In an embodiment, the unit 1310 may be configured to receive the offset from a network device.

Alternatively, the terminal device 1300 can be operative to perform the method 1000 as shown in FIG. 10. As shown in FIG. 13, the terminal device 1300 includes a unit (determining unit) 1310 configured to determine, in an RAR window, a time period during which the terminal device is not to monitor an RAR from a network device. The terminal device 1300 further includes a unit (monitoring unit) 1320 configured to monitor, in the RAR window, the RAR after the time period has lapsed.

In an embodiment, the time period may be determined based on one or more of: a distance between the terminal device and the network device, a location of the terminal device, or a previously determined time period during which the terminal device refrained from monitoring an RAR in an RAR window.

The units 1310 and 1320 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 7, 8, 9, or 10.

FIG. 14 is a block diagram of a terminal device 1400 according to another embodiment of the present disclosure. The terminal device 1400 can be e.g., a UE, operating in an NTN.

The terminal device 1400 includes a transceiver 1410, a processor 1420 and a memory 1430. The memory 1430 may contain instructions executable by the processor 1420 whereby the terminal device 1400 is operative to perform the actions, e.g., of the procedure described earlier in conjunction with FIG. 7. Particularly, the memory 1430 contains instructions executable by the processor 1420 whereby the terminal device 1400 is operative to receive, from a network device, DCI addressed to an RA-RNTI of the terminal device. The DCI contains an indication of an SFN.

In an embodiment, the indication may include a number of LSBs of the SFN.

In an embodiment, the DCI may have a DCI Format 1_0.

Alternatively, the memory 1430 may contain instructions executable by the processor 1420 whereby the terminal device 1400 is operative to perform the actions, e.g., of the procedure described earlier in conjunction with FIG. 8. Particularly, the memory 1430 contains instructions executable by the processor 1420 whereby the terminal device 1400 is operative to obtain an offset of a start of an RAR window. A gap between an end of a PRACH occasion and a start of a first available CORESET after the PRACH occasion that carries DCI scheduling an RAR is derivable from the offset. The memory 1430 further contains instructions executable by the processor 1420 whereby the terminal device 1400 is operative to monitor the RAR in the RAR window determined based on the offset.

In an embodiment, the offset may indicate a time length equal to the gap or the gap minus a duration of one OFDM symbol corresponding to an SCS for a Type 1 PDCCH CSS set.

In an embodiment, the operation of obtaining may include: determining the offset based on a type of the NTN. The type may include at least a satellite or an UAS.

In an embodiment, the operation of obtaining may include: receiving the offset from a network device.

Alternatively, the memory 1430 may contain instructions executable by the processor 1420 whereby the terminal device 1400 is operative to perform the actions, e.g., of the procedure described earlier in conjunction with FIG. 9. Particularly, the memory 1430 contains instructions executable by the processor 1420 whereby the terminal device 1400 is operative to obtain an offset of a start of an RAR window. A gap between an end of a PUSCH occasion for transmission of a MsgA PUSCH and a start of a first available CORESET after the PUSCH occasion that carries DCI scheduling a MsgB is derivable from the offset. The memory 1430 further contains instructions executable by the processor 1420 whereby the terminal device 1400 is operative to monitor the MsgB in the RAR window determined based on the offset.

In an embodiment, the offset may indicate a time length equal to the gap or the gap minus a duration of one OFDM symbol corresponding to an SCS for a Type 1 PDCCH CSS set.

In an embodiment, the operation of obtaining may include: determining the offset based on a type of the NTN. The type may include at least a satellite or an UAS.

In an embodiment, the operation of obtaining may include: receiving the offset from a network device.

Alternatively, the memory 1430 may contain instructions executable by the processor 1420 whereby the terminal device 1400 is operative to perform the actions, e.g., of the procedure described earlier in conjunction with FIG. 10. Particularly, the memory 1430 contains instructions executable by the processor 1420 whereby the terminal device 1400 is operative to: determine, in an RAR window, a time period during which the terminal device is not to monitor an RAR from a network device; and monitor, in the RAR window, the RAR after the time period has lapsed.

In an embodiment, the time period may be determined based on one or more of: a distance between the terminal device and the network device, a location of the terminal device, or a previously determined time period during which the terminal device refrained from monitoring an RAR in an RAR window.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1220 causes the network device 1200 to perform the actions, e.g., of the procedure described earlier in conjunction with FIG. 4, 5, or 6; or code/computer readable instructions, which when executed by the processor 1420 causes the terminal device 1400 to perform the actions, e.g., of the procedure described earlier in conjunction with FIG. 7, 8, 9, or 10.

The computer program product may be configured as a computer program code structured in computer program modules. The computer program modules could essentially perform the actions of the flow illustrated in FIG. 4, 5, 6, 7, 8, 9, or 10.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

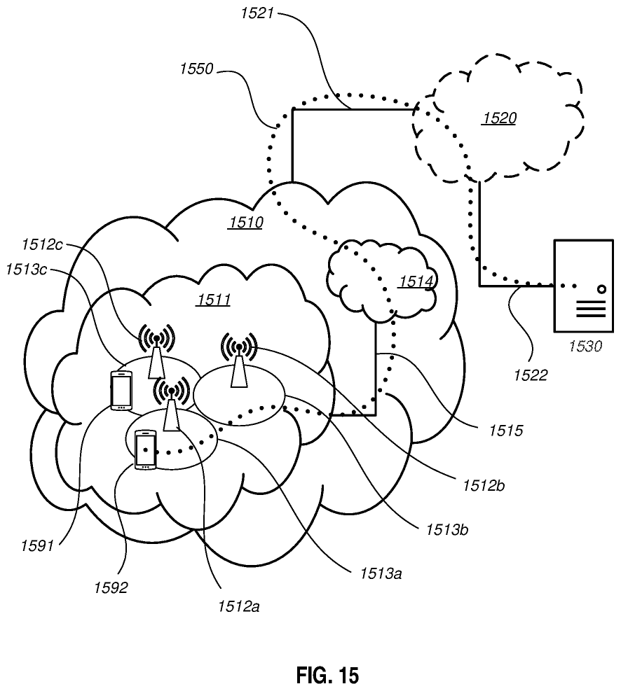

With reference to FIG. 15, in accordance with an embodiment, a communication system includes a telecommunication network 1510, such as a 3GPP-type cellular network, which comprises an access network 1511, such as a radio access network, and a core network 1514. The access network 1511 comprises a plurality of base stations 1512a, 1512b, 1512c, such as NBs, eNBs, gNBs or other types of wireless access points, each defining a corresponding coverage area 1513a, 1513b, 1513c. Each base station 1512a, 1512b, 1512c is connectable to the core network 1514 over a wired or wireless connection 1515. A first user equipment (UE) 1591 located in coverage area 1513c is configured to wirelessly connect to, or be paged by, the corresponding base station 1512c. A second UE 1592 in coverage area 1513a is wirelessly connectable to the corresponding base station 1512a. While a plurality of UEs 1591, 1592 are illustrated in this example, the disclosed embodiments are equally applicable to a situation where a sole UE is in the coverage area or where a sole UE is connecting to the corresponding base station 1512.

The telecommunication network 1510 is itself connected to a host computer 1530, which may be embodied in the hardware and/or software of a standalone server, a cloud-implemented server, a distributed server or as processing resources in a server farm. The host computer 1530 may be under the ownership or control of a service provider, or may be operated by the service provider or on behalf of the service provider. The connections 1521, 1522 between the telecommunication network 1510 and the host computer 1530 may extend directly from the core network 1514 to the host computer 1530 or may go via an optional intermediate network 1520. The intermediate network 1520 may be one of, or a combination of more than one of, a public, private or hosted network; the intermediate network 1520, if any, may be a backbone network or the Internet; in particular, the intermediate network 1520 may comprise two or more sub-networks (not shown).

The communication system of FIG. 15 as a whole enables connectivity between one of the connected UEs 1591, 1592 and the host computer 1530. The connectivity may be described as an over-the-top (OTT) connection 1550. The host computer 1530 and the connected UEs 1591, 1592 are configured to communicate data and/or signaling via the OTT connection 1550, using the access network 1511, the core network 1514, any intermediate network 1520 and possible further infrastructure (not shown) as intermediaries. The OTT connection 1550 may be transparent in the sense that the participating communication devices through which the OTT connection 1550 passes are unaware of routing of uplink and downlink communications. For example, a base station 1512 may not or need not be informed about the past routing of an incoming downlink communication with data originating from a host computer 1530 to be forwarded (e.g., handed over) to a connected UE 1591. Similarly, the base station 1512 need not be aware of the future routing of an outgoing uplink communication originating from the UE 1591 towards the host computer 1530.

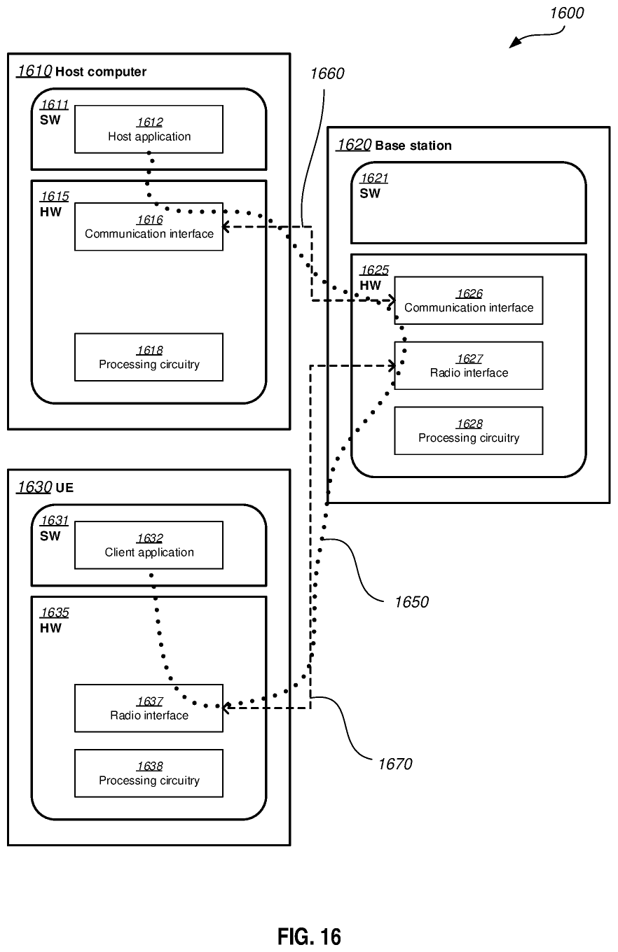

Example implementations, in accordance with an embodiment, of the UE, base station and host computer discussed in the preceding paragraphs will now be described with reference to FIG. 16. In a communication system 1600, a host computer 1610 comprises hardware 1615 including a communication interface 1616 configured to set up and maintain a wired or wireless connection with an interface of a different communication device of the communication system 1600. The host computer 1610 further comprises processing circuitry 1618, which may have storage and/or processing capabilities. In particular, the processing circuitry 1618 may comprise one or more programmable processors, application-specific integrated circuits, field programmable gate arrays or combinations of these (not shown) adapted to execute instructions. The host computer 1610 further comprises software 1611, which is stored in or accessible by the host computer 1610 and executable by the processing circuitry 1618. The software 1611 includes a host application 1612. The host application 1612 may be operable to provide a service to a remote user, such as a UE 1630 connecting via an OTT connection 1650 terminating at the UE 1630 and the host computer 1610. In providing the service to the remote user, the host application 1612 may provide user data which is transmitted using the OTT connection 1650.

The communication system 1600 further includes a base station 1620 provided in a telecommunication system and comprising hardware 1625 enabling it to communicate with the host computer 1610 and with the UE 1630. The hardware 1625 may include a communication interface 1626 for setting up and maintaining a wired or wireless connection with an interface of a different communication device of the communication system 1600, as well as a radio interface 1627 for setting up and maintaining at least a wireless connection 1670 with a UE 1630 located in a coverage area (not shown in FIG. 16) served by the base station 1620. The communication interface 1626 may be configured to facilitate a connection 1660 to the host computer 1610. The connection 1660 may be direct or it may pass through a core network (not shown in FIG. 16) of the telecommunication system and/or through one or more intermediate networks outside the telecommunication system. In the embodiment shown, the hardware 1625 of the base station 1620 further includes processing circuitry 1628, which may comprise one or more programmable processors, application-specific integrated circuits, field programmable gate arrays or combinations of these (not shown) adapted to execute instructions. The base station 1620 further has software 1621 stored internally or accessible via an external connection.

The communication system 1600 further includes the UE 1630 already referred to. Its hardware 1635 may include a radio interface 1637 configured to set up and maintain a wireless connection 1670 with a base station serving a coverage area in which the UE 1630 is currently located. The hardware 1635 of the UE 1630 further includes processing circuitry 1638, which may comprise one or more programmable processors, application-specific integrated circuits, field programmable gate arrays or combinations of these (not shown) adapted to execute instructions. The UE 1630 further comprises software 1631, which is stored in or accessible by the UE 1630 and executable by the processing circuitry 1638. The software 1631 includes a client application 1632. The client application 1632 may be operable to provide a service to a human or non-human user via the UE 1630, with the support of the host computer 1610. In the host computer 1610, an executing host application 1612 may communicate with the executing client application 1632 via the OTT connection 1650 terminating at the UE 1630 and the host computer 1610. In providing the service to the user, the client application 1632 may receive request data from the host application 1612 and provide user data in response to the request data. The OTT connection 1650 may transfer both the request data and the user data. The client application 1632 may interact with the user to generate the user data that it provides.

It is noted that the host computer 1610, base station 1620 and UE 1630 illustrated in FIG. 16 may be identical to the host computer 1530, one of the base stations 1512a, 1512b, 1512c and one of the UEs 1591, 1592 of FIG. 15, respectively. This is to say, the inner workings of these entities may be as shown in FIG. 16 and independently, the surrounding network topology may be that of FIG. 15.

In FIG. 16, the OTT connection 1650 has been drawn abstractly to illustrate the communication between the host computer 1610 and the use equipment 1630 via the base station 1620, without explicit reference to any intermediary devices and the precise routing of messages via these devices. Network infrastructure may determine the routing, which it may be configured to hide from the UE 1630 or from the service provider operating the host computer 1610, or both. While the OTT connection 1650 is active, the network infrastructure may further take decisions by which it dynamically changes the routing (e.g., on the basis of load balancing consideration or reconfiguration of the network).

The wireless connection 1670 between the UE 1630 and the base station 1620 is in accordance with the teachings of the embodiments described throughout this disclosure. One or more of the various embodiments improve the performance of OTT services provided to the UE 1630 using the OTT connection 1650, in which the wireless connection 1670 forms the last segment. More precisely, the teachings of these embodiments may improve the data rate, latency and power consumption and thereby provide benefits such as reduced user waiting time, and extended battery lifetime.

A measurement procedure may be provided for the purpose of monitoring data rate, latency and other factors on which the one or more embodiments improve. There may further be an optional network functionality for reconfiguring the OTT connection 1650 between the host computer 1610 and UE 1630, in response to variations in the measurement results. The measurement procedure and/or the network functionality for reconfiguring the OTT connection 1650 may be implemented in the software 1611 of the host computer 1610 or in the software 1631 of the UE 1630, or both. In embodiments, sensors (not shown) may be deployed in or in association with communication devices through which the OTT connection 1650 passes; the sensors may participate in the measurement procedure by supplying values of the monitored quantities exemplified above, or supplying values of other physical quantities from which software 1611, 1631 may compute or estimate the monitored quantities. The reconfiguring of the OTT connection 1650 may include message format, retransmission settings, preferred routing etc.; the reconfiguring need not affect the base station 1620, and it may be unknown or imperceptible to the base station 1620. Such procedures and functionalities may be known and practiced in the art. In certain embodiments, measurements may involve proprietary UE signaling facilitating the host computer's 1610 measurements of throughput, propagation times, latency and the like. The measurements may be implemented in that the software 1611, 1631 causes messages to be transmitted, in particular empty or ‘dummy’ messages, using the OTT connection 1650 while it monitors propagation times, errors etc.

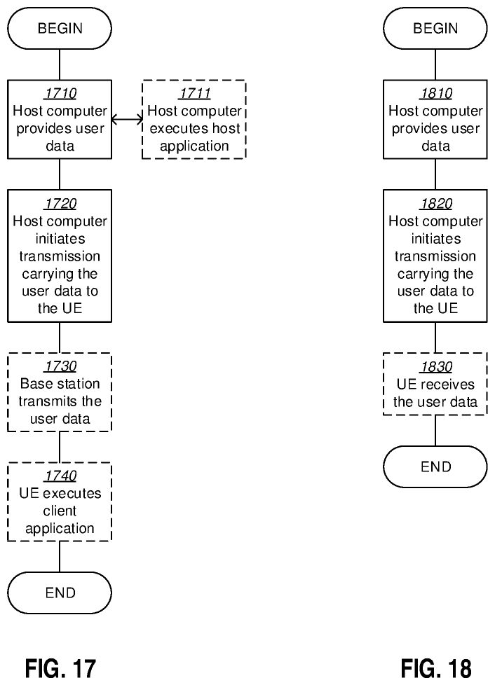

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section. In a first step 1710 of the method, the host computer provides user data. In an optional substep 1711 of the first step 1710, the host computer provides the user data by executing a host application. In a second step 1720, the host computer initiates a transmission carrying the user data to the UE. In an optional third step 1730, the base station transmits to the UE the user data which was carried in the transmission that the host computer initiated, in accordance with the teachings of the embodiments described throughout this disclosure. In an optional fourth step 1740, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section. In a first step 1810 of the method, the host computer provides user data. In an optional substep (not shown) the host computer provides the user data by executing a host application. In a second step 1820, the host computer initiates a transmission carrying the user data to the UE. The transmission may pass via the base station, in accordance with the teachings of the embodiments described throughout this disclosure. In an optional third step 1830, the UE receives the user data carried in the transmission.

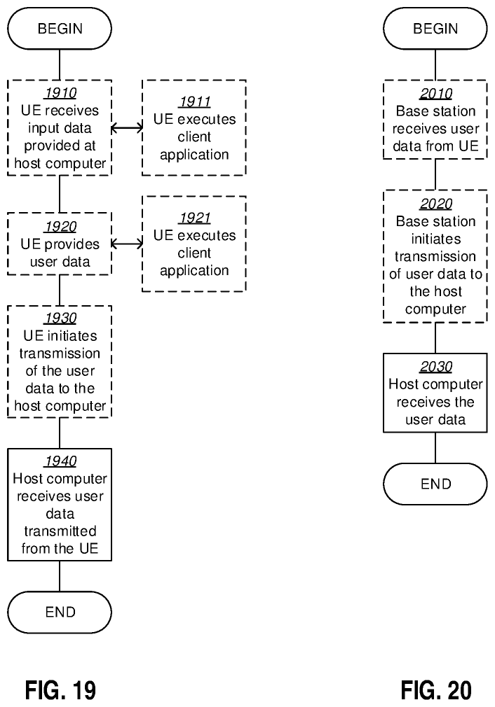

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section. In an optional first step 1910 of the method, the UE receives input data provided by the host computer. Additionally or alternatively, in an optional second step 1920, the UE provides user data. In an optional substep 1921 of the second step 1920, the UE provides the user data by executing a client application. In a further optional substep 1911 of the first step 1910, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1930, transmission of the user data to the host computer. In a fourth step 1940 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section. In an optional first step 2010 of the method, in accordance with the teachings of the embodiments described throughout this disclosure, the base station receives user data from the UE. In an optional second step 2020, the base station initiates transmission of the received user data to the host computer. In a third step 2030, the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1.-27. (canceled)

28. A method in a network device, the method comprising:
transmitting, to a terminal device, Downlink Control Information (DCI) addressed to a Random Access—Radio Network Temporary Identity (RA-RNTI) of the terminal device, the DCI containing an indication of a System Frame Number (SFN).

29. The method of claim 28, wherein the indication comprises a number of Least Significant Bits (LSBs) of the SFN.

30. The method of claim 28, wherein the DCI has a DCI Format 1_0.

31. The method of claim 28, wherein the network device operates in a Non-Terrestrial Network (NTN).

32. A method in a network device, the method comprising:
determining an offset of a start of a Random Access Response (RAR) window for a terminal device, wherein a gap between an end of a Physical Uplink Shared Channel (PUSCH) occasion for transmission of a Message A (MsgA) PUSCH and a start of a first available Control Resource Set (CORESET) after the PUSCH occasion that carries Downlink Control Information (DCI) scheduling a Message B (MsgB) is derivable from the offset; and
transmitting the MsgB to the terminal device based on the offset.

33. The method of claim 32, wherein the offset indicates a time length equal to the gap or the gap minus a duration of one Orthogonal Frequency Division Multiplexing (OFDM) symbol corresponding to a Sub-Carrier Spacing (SCS) for a Type 1 Physical Downlink Control Channel (PDCCH) Common Search Space (CSS) set.

34. The method of claim 32, wherein the network device operates in a Non-Terrestrial Network (NTN).

35. The method of claim 34, wherein the offset is determined based on a type of the NTN, the type comprising at least a satellite or an Unmanned Aircraft System (UAS).

36. The method of claim 32, further comprising signaling the offset to the terminal device.

37. A method in a terminal device, the method comprising:
obtaining an offset of a start of a Random Access Response (RAR) window, wherein a gap between an end of a Physical Random Access Channel (PRACH) occasion and a start of a first available Control Resource Set (CORESET) after the PRACH occasion that carries Downlink Control Information (DCI) scheduling an RAR is derivable from the offset; and
monitoring the RAR in the RAR window determined based on the offset.

38. The method of claim 37, wherein the offset indicates a time length equal to the gap or the gap minus a duration of one Orthogonal Frequency Division Multiplexing (OFDM) symbol corresponding to a Sub-Carrier Spacing (SCS) for a Type 1 Physical Downlink Control Channel (PDCCH) Common Search Space (CSS) set.

39. The method of claim 37, wherein the terminal device operates in a Non-Terrestrial Network (NTN).

40. The method of claim 39, wherein said obtaining comprises determining the offset based on a type of the NTN, the type comprising at least a satellite or an Unmanned Aircraft System (UAS).

41. The method of claim 37, wherein said obtaining comprises receiving the offset from a network device.
